(19) United States
(12) Patent Application Publication
(10) Pub. No.: US 2002/0154161 A1
(43) Pub. Date: Oct. 24, 2002

(54) Method and system for providing universal remote control of computing devices

(76) Inventors: Michael A. Friedman, Sammamish, WA (US); Timothy D. Lacy, Duvall, WA (US); Brendan McKeon, Seattle, WA (US)

Correspondence Address: THOMAS E. WATSON, WOODCOCK WASHBURN KURTZ, MACKIEWICZ & NORRIS LLP, One Liberty Place - 46th Floor, Philadelphia, PA, 19103, US

(21) Appl. No.: 09/775,033

(22) Filed: Feb. 1, 2001

(51) Int. Cl. G09G 5/00; G10L 21/00; G10L 19/02

(52) U.S. Cl. 345/740; 345/866; 345/749; 345/709; 704/203

(57) ABSTRACT

A universal console (UC) platform for a UC device is provided. The user sets up or initializes the UC by describing his or her preferences and disabilities. The UC digests and stores this user information. Later, as the user encounters various devices and applications to be controlled, and indicates a desire to control a particular device, the device to be controlled or other source sends a canonical user interface (UI) description of the device's UI to the UC. The canonical UI description adheres to an abstract format to describe in high-level terms the functionality of the device's UI.

From the canonical UI representation, the UC device is capable of recognizing (1) the action-commands to which the device responds including parameters and (2) the decisions, selections, and input the user needs to provide for the console to determine which action-commands to send and the values of the action-command parameters. Generally, this implicates group hierarchy, from which the user is able to choose what he or she wants the device to perform, and the UC is able to gather the parameter values associated with the action-commands to carry out the user's wishes. Additionally, the UC device is capable of receiving status, state changes and other notifications from a device within its control.

### FIELD OF THE INVENTION

This invention relates generally to a method and system for providing universal remote control of any type of computing device via a common abstracted language. More particularly, this invention relates to a method and system for providing a remote control experience tailored to a user, based upon a common abstracted user interface language capable of being understood by a variety of computing devices, including household appliances, and anything having a user interface for control.

### BACKGROUND OF THE INVENTION

There are a myriad of devices that do not share a common user interface, mainly because user interfaces tend to be device specific. There are also a myriad of circumstances under which it is desirable to tailor a user interface experience to a particular user.

For a first example, video cassette recorders (VCRs) tend to have play, pause, rewind, fast forward, clock setting, volume adjustment and other like functionality associated with the user interface for the VCR. Most VCRs include buttons on the VCR, as well as a remote control tailored to the VCR's operations.

For a second example, televisions (TVs) tend to have volume adjustment, channel changing, brightness control, contrast control and other like functionality. Typically TVs can also be controlled by buttons on the device as well as by remote control.

For a third example, microwave ovens tend to have cooking controls, such as temperature control, timing control as well as clock, and other specialized functionality. The user interface of a microwave oven generally contains simple buttons, and a numerical keypad.

With respect to the above three examples, a first problem is that a user cannot currently control all three of the devices with the same device. While universal remote control devices exist that can accommodate the first and second examples, a way of interacting with the microwave oven with a universal remote control device does not exist.

A second problem is that even in the case of placing TV and VCR remote functionality in the same universal remote device, this is accomplished by storing device specific information, provided by the manufacturer, in the universal remote control device. While the same keys of the universal remote control device may be used to raise or lower the volume output of the VCR and TV, effectively it is as if the user places the two separate device specific remote control devices in the universal remote control, and toggles back and forth between the two separate remotes. In other words, there is no common language as between the controls for the VCR and the controls for the TV.

A third problem is that universal remote control devices currently do not allow a user to tailor the universal remote to himself or herself. Instead, if the user is blind, for example, there is no way to present the data to the user in Braille. While for a given device, such as a TV, Braille devices exist for the purpose of allowing a blind user to interact effectively with the device, this gets back to the original problem of not having a common Braille device for interacting with a plurality of different devices.

A concrete failing of current systems as a result of the above problems can be demonstrated by the following discussion relating to interaction with devices from people having disabilities. Currently, users can add accessibility aids such as screen readers, screen enlargers, and Braillers to their PCs. Unfortunately, users cannot add aids to the myriad of smart appliances and devices that are increasingly becoming part of their world. The problem is that in the near future, users will encounter smart appliances and other devices at work, at home, at the store, at the airport, etc. These devices will generally not have the memory, processing power, peripherals, or development budget to be accessible on their own. Thus, there is no common way for providing disability aids to devices of all kinds through a common syntax.

Thus, it would be desirable to provide a system in which a user can control a plurality of different and unrelated computing devices beyond the capabilities of current universal remote control devices. It would be further desirable to provide a common language for use in connection with controlling a plurality of different computing devices. It would be still further desirable to provide a universal remote control device capable of allowing a user to tailor the universal remote control experience to himself, herself or even itself in the case where the user is another type of computing device.

### SUMMARY OF THE INVENTION

The present invention provides a universal console (UC) platform for a UC device. The user sets up or initializes the UC by describing his or her preferences and disabilities. The UC digests and stores this user information. Later, as the user encounters various devices or applications to be controlled, and indicates a desire to control a particular device, the device to be controlled or other source sends a canonical user interface (UI) description of the device's UI to the UC. The canonical UI description adheres to an abstract format to describe in high-level terms the functionality of the device's UI.

From the canonical UI representation, the UC device is capable of recognizing (1) the action-commands to which the device responds including parameters and (2) the decisions, selections, and input the user needs to provide for the console to determine which action-commands to send and the values of the action-command parameters. Generally, this implicates group hierarchy, from which the user is able to choose what he or she wants the device to perform, and the UC is able to gather the parameter values associated with the action-commands to carry out the user's wishes. Additionally, the UC device is capable of receiving status, state changes and other notifications from a device within its control.

Other features of the present invention are described below.

### BRIEF DESCRIPTION OF THE DRAWINGS

The system and methods for providing dynamic authorization in a computer system are further described with reference to the accompanying drawings in which:

FIG. 1 is a block diagram representing an exemplary computer and network environment in which the present invention may be implemented;

FIG. 2 is a block diagram illustrating an exemplary communications protocol for communications between a universal console and controlled device or application in accordance with the present invention;

FIG. 3 is a block diagram illustrating typical communication events occurring between a universal console and controlled device or application in accordance with the present invention;

FIGS. 4A through 4D are exemplary screenshots of a Windows® based implementation of the present invention; and

FIG. 5 is a flow diagram illustrating an exemplary sequence of events in accordance with the present invention.

### DETAILED DESCRIPTION OF PREFERRED EMBODIMENTS

Overview

In accordance with the present invention, a syntax is defined that abstracts the language of user interfaces in general so as to enable any device that adheres to the syntax to be controlled from a common universal remote device, such as a handheld computer or the like. For example, a DVD player works in part in connection with menus that may be navigated with arrows and a select button. Many other devices also work in connection with such a menu driven solution. To the extent that an abstract language may be described in terms of navigating left, selecting an item based on a navigation position, selecting an element X from a set A, or like abstract user interface constructs, each device's user interface may be transformed into a collection of these types of abstract user interface building blocks. Thus, once the user interfaces of the TV, VCR and microwave are abstracted into these building blocks, each of the user interfaces may be understood by the universal control device of the present invention, and thus each of the devices may be controlled by the universal control device.

Since each of the abstract user interface descriptions share a common language, a specification by the user regarding the user's preferences may be applied to each of the descriptions so that the user is always presented with a preferable user interface. For example, a blind person may specify that he or she is blind, and a Braille user interface may be applied for each device being operated. Text may accompany any of the abstract building blocks as well, which may be rendered visually, by voice, by feel, etc. Different languages may also be accommodated for the same reason. Defining in a syntax only the abstract functionality necessary or common between all user interfaces thus enables the presentation of the ultimate user interface to be tailored to the user.

A connection to the Internet allows the universal control device of the present invention to optionally find device descriptions while on-line. Also, since some devices such as different VCRs, have shared commands, at least a minimal amount of abstracted description may apply to all VCRs and thus most VCRs may be controlled with the minimal amount of abstracted description. To supplement such a minimal amount of abstracted description, the universal control device of the present invention may request more specific information about the abstracted description from the device itself, the Internet or another source to form a complete user interface for the device.

In operation, when the universal remote control device of the present invention is turned on or initialized, the devices that it will control are prompted and then deliver a packet of information reflecting the abstract building blocks of the device(s)' user interface to the universal remote control device. In an exemplary embodiment, this packet of information is delivered in extensible markup language (XML). Based on a user's preferences, this packet of information about a device's user interface is tailored to the user as part of the user interface of the universal remote control device. Communications from the universal remote control device to the devices occur as a result of the user interacting with the tailored user interface. In an exemplary embodiment, XML is utilized for these communications as well. Devices may also communicate notifications to the universal remote control, such as temporally dependent information or state changes.

Exemplary Computer and Network Environments

A computer 110 or other client device can be deployed as part of a computer network. Thus, the present invention pertains to any computer system having any number of memory or storage units, and any number of applications and processes occurring across any number of storage units or volumes. The present invention may apply to an environment with server computers and client computers deployed in a network environment, having remote or local storage.

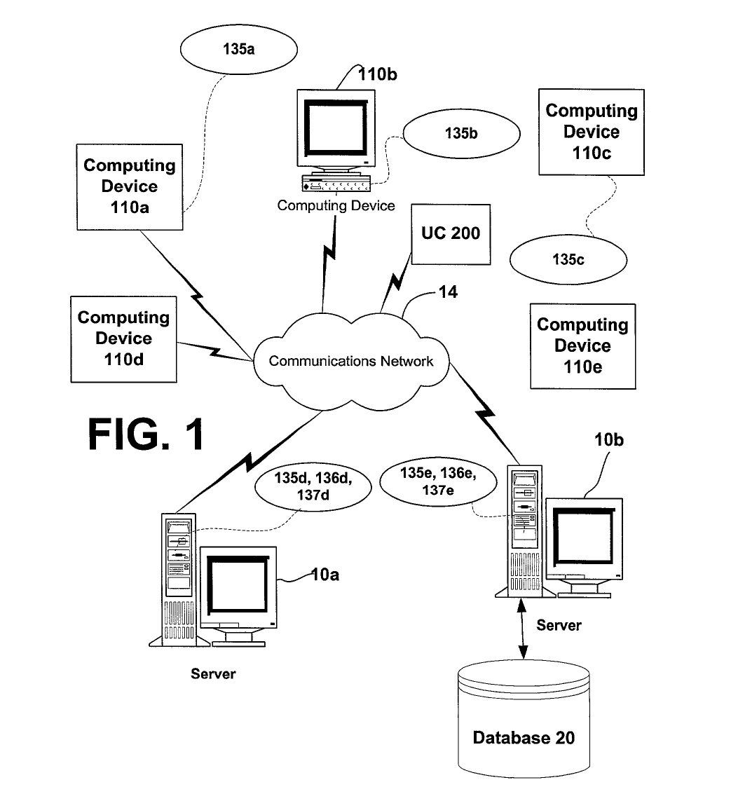

FIG. 1 illustrates an exemplary network environment, with a server in communication with client computers via a network, in which the present invention may be employed. As shown, a number of servers 10a, 10b, etc., are interconnected via a communications network 14 (which may be a LAN, WAN, intranet or the Internet) with a number of client or remote computing devices 110a, 110b, 110c, 110d, 110e, etc., such as a portable computer, handheld computer, thin client, networked appliance, or other device to be controlled, such as a VCR, TV, heater and the like in accordance with the present invention. In a network environment in which the communications network 14 is the Internet, for example, the servers 10 can be Web servers with which the clients 110a, 110b, 110c, 110d, 110e, etc. communicate via any of a number of known protocols such as hypertext transfer protocol (HTTP). Communications may be wired or wireless, where appropriate. Client devices 110 may or may not communicate via communications network 14, and may have independent communications associated therewith. For example, in the case of a TV or VCR, there may or may not be a networked aspect to the control thereof. Each client computer 110 and server computer 10 may be equipped with various application program modules 135, other program modules 136 and program data 137, and with connections or access to various types of storage elements or objects, across which files may be stored or to which portion(s) of files may be downloaded or migrated. Any server 10a, 10b, etc. may be responsible for the maintenance and updating of a database 20 in accordance with the present invention, such as a database 20 for storing canonical user interface descriptions. Thus, the UC 200 of the present invention can be utilized in a computer network environment having client computers 110a, 110b, etc. for accessing and interacting with a computer network 14 and server computers 10a, 10b, etc. for interacting with client computers 110a, 110b, etc. and other devices 111 and databases 20. Thus, when a UC 200 is brought into such an exemplary environment, the UC 200 may communicate with various client computers 110 and devices 111 via the communications network 14, or other wired and/or wireless means.

Universal Remote Control User Interface Mechanism

The present invention provides a common syntax for the universal control of computing devices. A universal console platform for a UC device 200 is provided, whereby the user sets up or initializes the UC 200 by describing his or her preferences and disabilities. The UC 200 digests and stores this user information. Later, as the user encounters various devices or applications to be controlled, such as devices 110a, 110b, 110c, 110d, 110e, etc. and applications 135a, 135b, 135c, etc. of FIG. 1, and indicates a desire to control a particular device or application, the device or application to be controlled sends a canonical user interface (UI) description of its UI to the UC 200. The canonical UI description may also come from another source. The canonical UI description adheres to an abstract format to describe in high-level terms the functionality of the device's UI.

From the canonical UI representation, the UC device 200 is capable of recognizing both the action-commands to which the device responds including parameters and as well as the decisions, selections, and input the user needs to provide for the UC 200 to determine which action-commands to send and the values of the action-command parameters. The user can input what he or she wants the device to perform, and the UC 200 can gather the parameter values associated with the action-commands. Additionally, the UC device 200 is capable of receiving status, state changes and other notifications from a device within its control.

The software that drives the UC 200 may be wholly located on a single computing device, or variously distributed in a server/thin client environment. Thus, the processing that occurs on the device that ultimately displays or renders the concrete UI to the user may range anywhere from all of the processing to just enough processing to render the concrete UI to the user and to receive and transmit data. In other words, the UC 200 may operate in connection with server(s) that perform the data processing of the canonical UI description. Thus, as used herein, UC 200 may describe one or more computers or devices, having distributed software for causing the methodology described herein to occur. Additionally, since devices to be controlled by the UC 200 of the present invention include an application to be controlled, the device to be controlled (the application) and software for the UC 200 may be co-located on the same computing device. As used herein, controlled device, where not explicitly stating so, also may refer to an application executing on a computing device.

Further, where a server performs the functionality or partial functionality of the UC 200 and a ‘dumb’ or thin client device is utilized for its display or rendering capabilities to a user, as described above, the client device may register its display properties with the server in order to facilitate the translation of data from the server to the client device.

As related in the background, one use for the present invention relates to accessible user interfaces, which are user interfaces that are usable by persons with disabilities. For example, users who are blind, color blind or deaf, users who cannot use a keyboard or mouse due to a physical disability and users with cognitive disabilities fall into this category. In particular, this invention provides a scheme by which a wide variety of devices and applications can be made accessible at a low cost and in a standardized manner. Specifically, the canonical User Interface (UI) of the present invention provides standard notation by which a controlled device or application (e.g. a VCR, TV, handheld computer, piece of software, or microwave oven) communicates an abstract representation of its UI to a device or application called a UC 200. The UC 200 provided in accordance with the present invention renders the abstract UI as a concrete UI that takes into account the user's stored preferences and disabilities. As a result of the user's interaction with the concrete UI, the UC 200 sends action-commands to the controlled device. The controlled device carries out the actions and sends notifications, messages, state changes and the like back to the UC 200.

It can be appreciated that references to an “abstract UI,” as used herein, says nothing about the visual appearance or layout of UI elements. Further, references to an abstract UI do not suggest that the UI as actually rendered or communicated must be visible i.e., it could be tactile or speech-based. The abstract UI, as used in accordance with the present invention, describes the minimum output the user needs to perceive, and the minimal decisions and values the user needs to furnish for the device or application or device to function, without adding any additional conceptual metaphor or bells and whistles.

The UC 200 could ultimately present a high contrast GUI, speech, or Braille. The UC 200 could adapt to cognitive and learning disabilities, and so on. Thus, in accordance with the present invention, the UC 200 is afforded the maximum flexibility to fashion the concrete UI that the user of the UC 200 finally sees, by having the device expose the minimum requirements that a UI for that device must meet. This allows vendors to create UCs 200 to cater to a breadth of common and rare disabilities and combinations of disabilities that are not adequately addressed today.

The controlled device or application does not have to know anything about disabilities in general nor address any specific disability. The controlled device instead transmits a canonical UI description of its UI describing its UI in abstract, minimalist, and almost mathematical terms. The UC 200 understands the disabilities and renders a concrete UI accordingly. But a particular user's UC 200 does not have to understand all disabilities, only the disabilities that the user has. Thus, any commercial UC 200 would need to address only some subset of disabilities. For extremely rare disabilities, a developer may need to configure or customize a UC 200 for the user.

Thus, the Canonical UI of the present invention has been developed as a way for a device or application to represent a high-level logical model that can be exposed to client software.

As technological advances go beyond the desktop and the enterprise and into smart appliances and other smart devices and as these devices become more and more utilized, it is important for legal, moral, and business reasons that persons with disabilities can use them, at home, at work, and everywhere else. The UC paradigm of the present invention offers tremendous cost saving advantages in hardware and development costs. In accordance with the present invention, all such a device is required to do to be accessible is to be able to send out a description of its abstract UI (or indicate where a UC 200 may find such a description), such as could be implemented in the form of an XML data stream. Having relinquished a high level representation of the device's UI, the device itself does not need to have the hardware and software to address each user's special needs. The UC 200 could be included with an operating system release or produced separately for a product that accommodates common disabilities, and distributed variously across computing devices. The canonical UI of the present invention could also be provided for use in connection with a Web browser via XML, so as to enable attachment to web pages.

One advantage of the UC 200 is that people with special needs or preferences can carry a UC device 200. The user sets up the UC 200 once by describing his or her preferences and disabilities. The UC 200 digests and stores this information. Later, as the user encounters various devices and indicates a desire to control a particular device, that device sends a canonical UI description of its UI to the UC 200.

From the Canonical UI representation, the UC 200 recognizes (1) the action-commands that the device responds to, including parameters and (2) the decisions, selections, and input the user needs to provide for the console to determine which action-commands to send and the values of the action-command parameters.

In representing the abstract UI, the specifier organizes commands into a hierarchy of groups. A group can also include commands and subgroups (each of which is also a group).

A command tells the controlled device or application to do something, for example, record, rewind, or play. To cause the device or application perform that command, the UC 200 sends a sequence of one or more calls, such as SOAP method calls, to the device or application. These calls are in the XML description of the command.

Each call, such as a SOAP call, may have zero or more parameter values associated therewith. Each command includes a set that defines all the parameter values needed for the SOAP calls. The definition includes the data type (the domain of permissible values) and pieces of text that describe the parameter and the user's options. The UC 200 uses the information about the parameter to present a UI element to the user, for example a control or a menu or a non-visual analogue of those, to the user to gather the value.

The UC 200 is free to request and/or accept the value of the parameter in a graphical, textual, speech-based, tactile, or other manner in accordance with the user's preferences and disabilities.

The default, although it might be otherwise implemented, is that the UC 200 is free to solicit parameter values even before they are needed for a method call, such as a SOAP method call. For example, the UC 200 might have “Channel#” on a form along with the commands “record” and “play.” If the user fills in the Channel# and subsequently chooses the “record” command, the UC 200 does not have to ask for the channel. If the user leaves the Channel# blank, the universal console might pop up a dialog requesting the Channel#. Note that the dialog might have “OK” and “Cancel” buttons, but these buttons are not device commands; they are just part of the concrete UI the UC 200 has created.

The UC 200 might also choose to accept a parameter value unsolicited. An example of the unsolicited case is in a speech-based UI in which the user can say, “Record,” or “Record channel 7,” or “Record channel 7 at 6:00 PM.”

Including the option “<modal/>” in a group implies modality, that is, the UC 200 should “hold back” presenting the group to the user. The group should then behave similarly to a dialog and “pop up” in response to the user making a choice.

The UC 200 determines what visual control or other means is used to obtain the parameter value. For example, a “select one” type of parameter value can be implemented by a list box or menu or by some speech or Braille. For visual controls, the UC 200 determines the number of screens and the layout of the controls.

The UC 200 has great latitude in deciding how to gather information from the user. It does not matter how the concrete UI the UC 200 presents looks or feels or sounds like, as long as the UC 200 can determine what the user wants the device to do (which determines the action commands to send to the device) and the parameters. While it can be appreciated that numerous variations of a canonical UI representation may exist, an exemplary canonical UI representation that might be utilized in connection with a command that enables a robotic dog to jump, and the accompanying exemplary textual data that may be used in different ways for rendering the concrete UI, might be as follows:

<group>

<group_name> Roboto Dog </group_name>

<top_level/>

<explanation> What trick would you like your Robo Dog to perform?
</explanation>
<command>

<name> Double Roll Over </name>
<prompt> Tell Roboto Dog to perform Double Roll Over

Trick </prompt>

<action> Roll_Over </action>
<action> Roll_Over </action>

</command>
<command>

<name> Jump_Trick </name>
<prompt> Tell Roboto Dog to Jump </prompt>
<action>

Jump

</action>

</command>
<command>

<select_one>

<name> Direction </name>
<prompt> Please tell Roboto Dog the direction you want

him to jump </prompt>

<option> Forward </option>
<option> Sideways </option>
<option> Back </option >

</select_one>
<select_integer>

<name> Distance </name>
<prompt> How far in meters?</prompt>
<min> 0 </min>
<max> 5 </max>
<default> 3 </default>

</select_integer>
<action>Jump(Direction, Distance)</action >

</command>

</group>

The canonical UI of the present invention can be expanded to include real-time capability. By adding more concepts and constructs, it is possible to use the canonical UI for controlling ongoing real-world processes. Advantageously, this may open many job opportunities to persons with disabilities that have heretofore been closed to them.

The canonical UI architecture of the present invention consists of two components: (1) The UC 200 and (2) controlled devices or applications.

The UC 200 is an application running on a PC or some other general-purpose or dedicated device, or it may be a hosted service for a user device. Preferably, it is a portable device that has wireless communication capabilities.

The UC 200 may be provided with a set-up or initialization program that collects information about a user's preferences and disabilities. The UC 200 may also be pre-set for certain fixed disabilities or preferences. The UC 200 also has the ability to determine what devices are available for the user to control and allows the user to select one or more of those devices. The UC 200 has the ability to request from the device a Canonical UI representation of the device's UI. The UC 200 has the capability to transform the abstract UI described in the canonical UI into a concrete UI, taking into account the user's stored preferences and disabilities. The concrete UI is not necessarily visual but could be tactile, speech-based, or something entirely novel. The UC 200 has the ability to send action-commands to the controlled device or application. The UC 200 determines which action-commands and what parameter values to send, based on the decisions, selections, and input the user provided when interacting with the concrete UI.

As mentioned, the UC 200 functionality can also be distributed over two or more devices as well such as an “accessibility server” and a thin client device that handles Input/Output.

The second component of the architecture of the present invention is the controlled device or application. The controlled device or application is a smart appliance, a home automation device, an application running on a PC, a kiosk, a set-top box, or any other device, networked or otherwise, that can communicate with the UC 200 of the present invention. Using the canonical UI description of the present invention, the controlled device or application can send the UC 200 an abstract representation of the device's UI including a description of the action-commands that the device accepts. These action-commands would typically be remote procedures that can be called via standard communication protocols, such as Simple Object Activation Protocol (SOAP). Each action-command may have zero or more parameters.

Notifications are output-only communications from the controlled device or application to the UC 200. These include error, warning, status, and informational messages.

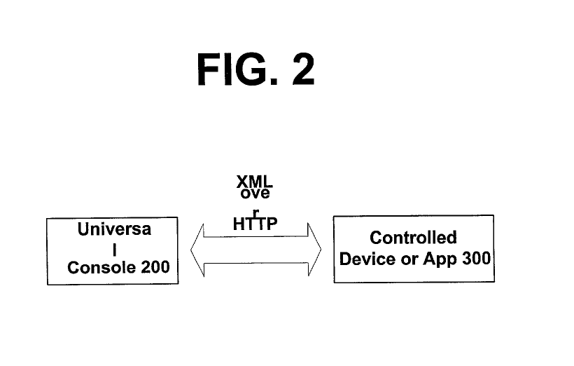

A conventional or wireless network interconnects the UC 200 and the controlled device or application, and as shown in FIG. 2, in an exemplary embodiment, UC 200 may communicate with a controlled device 300, and vice versa, via HTTP, although it is understood that the communication protocol for communicating to controlled devices 300 need not be the same for communicating from controlled devices 300 to UC 200. Also, the UC 200 can handle multiple devices concurrently, as can an accessibility server, if employed. Also, the canonical UI description of a device's or application's UI, or an update or current version thereof, may also be transmitted to the UC 200 via a server or other source via a network, or any other known location for retrieving the canonical UI description. As long as the UC 200 understands where to find or look for the canonical UI description, the UC 200 may receive the canonical UI description from any source.

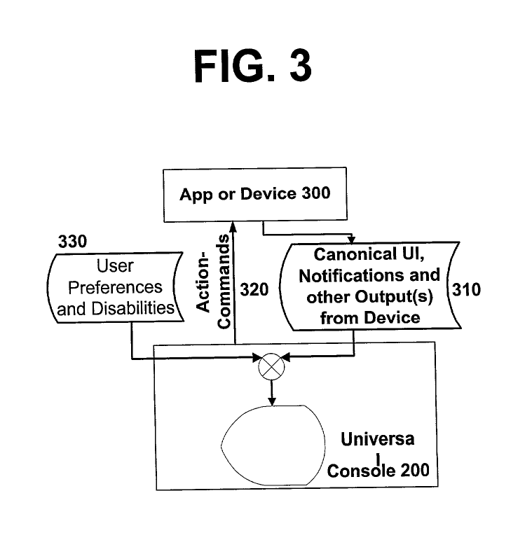

In a rudimentary fashion, FIG. 3 illustrates exemplary communications that occur in accordance with the present invention. A user interacts with a universal console 200 in order to specify a set of preferences to be communicated to UC 200 along communications channel 330, which may include specifying a disability such as blindness, color blindness, etc. Once a user has located an application or device 300 to control with the UC 200, the UC 200 receives a canonical UI description along communications channel 310. As mentioned previously, the canonical UI description may come from alternate sources as well. Notifications and other output(s) from device 300 may also be communicated via channel 310. The UC 200 renders a concrete UI to the user of the UC 200, so that the user may communicate action-commands with associated parameters to the application or device 300 being controlled along communications channel 320.

In a typical scenario, before a vendor brings a device to market, the vendor designs a canonical UI representation of the device's UI in accordance with the specification of the canonical UI syntax, described below. The vendor may do this directly, or the vendor could automate the transformation of an HTML-based UI into a canonical UI via abstraction. In one embodiment, the result is an XML stream that describes the action-commands the device accepts and an abstract UI that enables the user to choose what he or she wants the device to do, determining which action-commands the UC 200 should invoke. Also, for each action-command that has parameters, the canonical UI includes a description, such as an XML description, for gathering the values of those parameters.

As mentioned, a canonical UI representation of a UI is based on a group hierarchy. The UC 200 determines what control to use to implement a parameter. For example, “select one element of a set” can be implemented by a list box or menu or by some speech or Braille. The UC 200 also determines the number of screens and the layout of the controls.

Appendix A and Appendix B, respectively, show an XML lexicon of exemplary canonical UI input constructs and an XML lexicon for exemplary canonical UI output constructs. These tables, for example, include enough information to construct an XML schema. It can be appreciated by one of ordinary skill in the art that these schema used to express these constructs may be designed according to a variety of notations, wherein XML is just one implementation. The concepts behind the UI constructs may thus be duplicated for a variety of formats.

Some additional constructs that could also be implemented include the following:

1. <structure>: for entering structured values

2. <select_date> for calendar programs

3. <select_time> for appointment schedulers and VCR remote controls

4. <select_tristate> for yes/no/maybe choices. (See Word Format Font dialog when you have selected a string that is sometimes normal and sometimes bold.)

5. <select_order> for selecting and ordering a list. (combination of <select_many> and <order>)

6. <enter_integer>, <enter_date>, <enter_time>: compare to <select_one> and <enter string>. Should have <min _value> and <max_value> as options

7. <select_color>

8. <select_font>

9. <select_directory>: given a root UNC or URL

10. <select_file>: given a root UNC or URL

11. <static>: string

12. <select_person>: given an address book

13. <select_location>: given an address book

14. <grid>: for entering and viewing database or spreadsheet values

In this regard, <grid> parameters could include the following:

1. <header_row>

2. <prototype_row>

3. <prototype_column>

4. <allow_insertdelete_row>

5. <allow_insertdelete_column>

6. <allow_reorder-row>

7. <allow_reorder_column>

8. <allow_expandcollapse_row>

9. <allow_expandcollapse_column>

10. <allow_hidereveal_row>

11. <allow_hidereveal_column>

12. <row>

13. <cell>

14. <header_cell>

15. <row_group>

16. <cell_group>

Thus, both the canonical UI and the notifications can include accessible matrices, or abstractions of tables. The user can traverse the matrix by row, by column, and for sparse matrices, can ask for the next non-NULL entry. Canonical UI constructs may thus apply to both the canonical UI description itself, as well as notification communications.

For flexibility, in one embodiment, each cell contains one or more attributes. If the cell contains one element and there is no header row defined, all the attributes in a column should have the same prompt and the prompt becomes the header for the column. If a cell contains more than one element, all cells in a column should contain the same number of attributes, corresponding attributes should all have the same prompt. The prompt becomes a sub header. The user can choose to display the sub header under the header row or to the right of the header column in the manner of pivot tables. If a table grid row is to be inserted, a prototype row may be utilized to give the initial attributes for the row. If a grid allows columns to be inserted, a prototype column may be utilized to give the initial attributes for the column.

If a grid allows rows to be reordered, the UI may offer sort by column. If a grid allows columns to be reordered, the UI may offer sort by row. If a grid allows rows to be hidden, the UI may offer filter by column. If a grid allows columns to be hidden, the UI may offer filter by row. An expand/collapse row and/or expand/collapse column would support hierarchies like project/subproject, site/service/network, and year/month/day. Other grid functionality might include <pivot_table>, used for viewing cube values.

Other exemplary cell attributes may include any of the following:

1. <password>: a value can be typed but not seen, copied, or cut.

2. <challenge>: a public key with which to encrypt the password before transmission.

3. <min_length>: useful for strings.

4. <max_length>: useful for strings.

5. <readonly>: a value can be read or seen and copied, but not modified.

6. <enable_when>: enable the option or parameter when another parameter has the specified value. Use in Page range section of Print dialog for Microsoft Word.

7. <pattern>: used for entering telephone numbers, zip codes, postal codes, social security numbers, etc.

8. <allow html>: allow HTML tags like <B>, <I>, <P>, <U>, <UL>, <OL>, <SL> inside string fields for a richer text experience.

9. <option_group>: This puts options into a group that can be expanded or collapsed like a tree. For <select_one>, there can be an indication whether the <option_group> itself can be selected. For <select_multiple>, the <option_group> can be used to select or deselect any or all option groups under it.

10. <special_value>: This allows a special value like NULL, N/A, NaN, #ERROR! to be entered into a control, even though it does not satisfy patterns or other rules.

11. <object>: An option for <select_one> or <select_multiple> could be an object. Objects can have <command>s associated with them. If an object has a <command> associated with it, the command's <action> can have a <this_object> parameter. A command associated with an object could appear on the right click menu of the object, or could be a pushbutton that is automatically enabled when an object that can use it is selected.

While the above-described attributes have been discussed in the context of cells, they are more general concepts and may be applied more generally to other constructs such as command parameters. The above description of an exemplary canonical UI thus outlines some typical functionality that may be exploited in connection with a controlled device or application 300 of the present invention. In general, a parameter can be thought of as an abstraction of a control (called widget, gadget, component, etc., outside Win32) or menu. It does not imply a particular visual or nonvisual appearance and describes a kind of abstract mathematical operation the user needs to perform, such as choosing one element from a set and other examples from the Appendices. The UC 200 is free to implement the actual rendering of the UI in a graphical, textual, speech-based, tactile, or other manner in accordance with the user's preferences and disabilities.

The above described group hierarchy parameters do not imply a particular layout or layering. When the user invokes a command, the UC 200 invokes an action on the device or application 300. Prior to invoking the action-command, the UC 200 may present the user with a UI in order to obtain parameter values for the action-command. The user interface element may have UC-provided OK and Cancel commands. If the user chooses the OK command, the UC 200 gathers the values of the parameters from the parameters and invokes the actions. If the user invokes the Cancel command, the UC 200 dismisses the action command and rescinds the command that initiated processing of the associated group hierarchy.

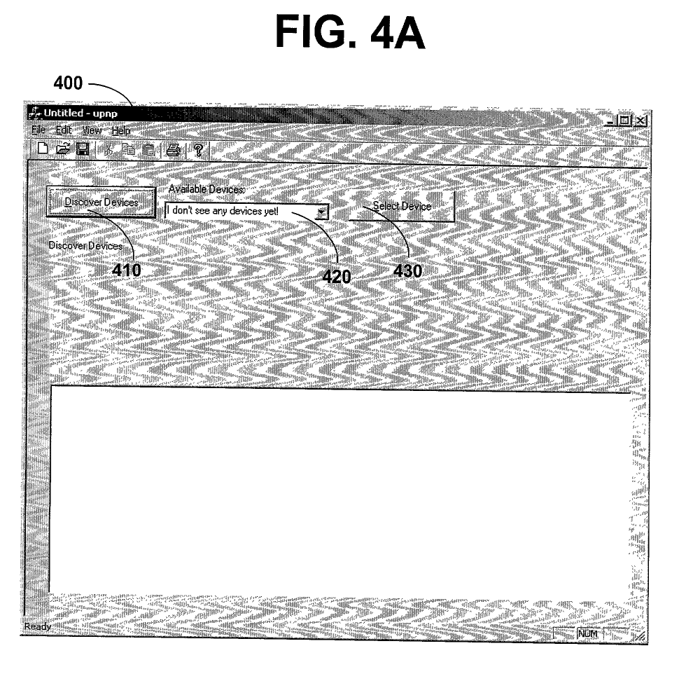

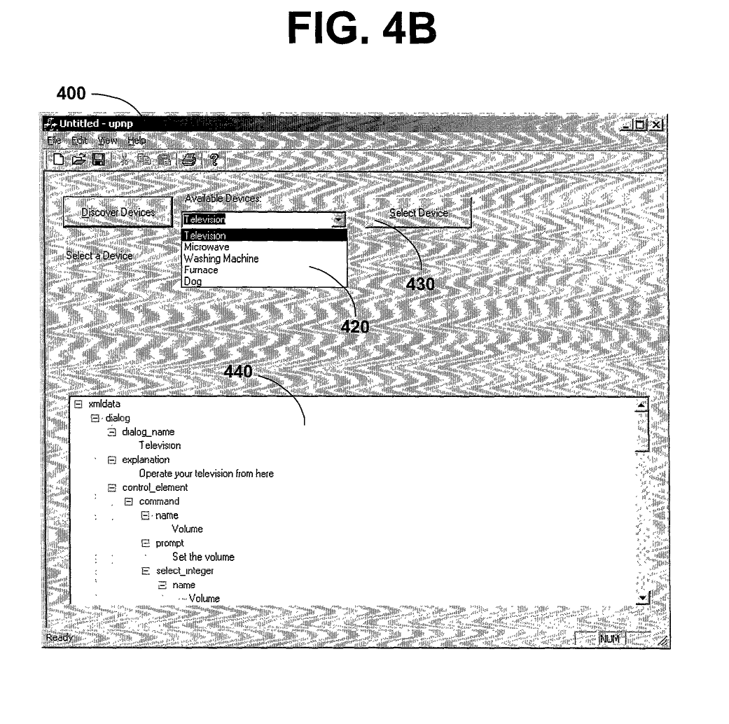

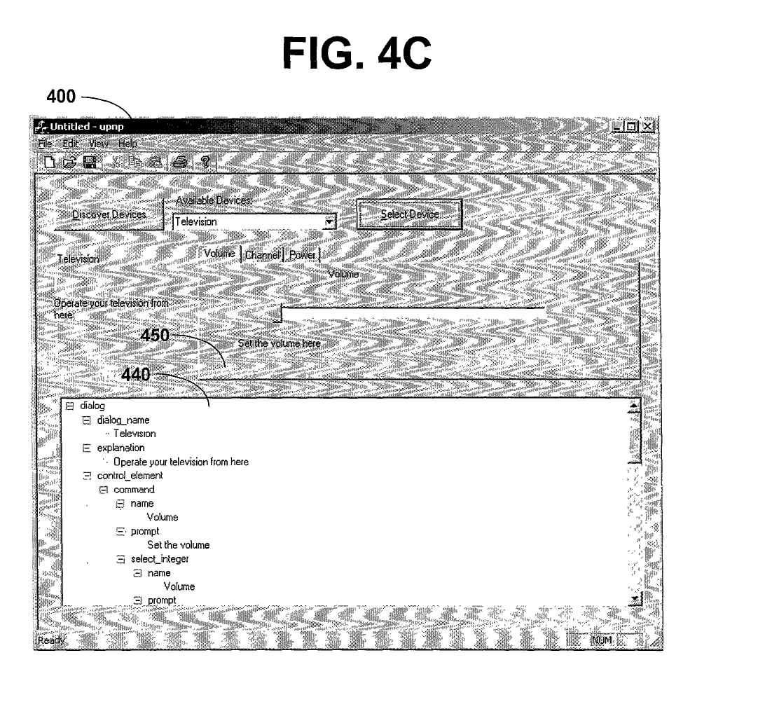

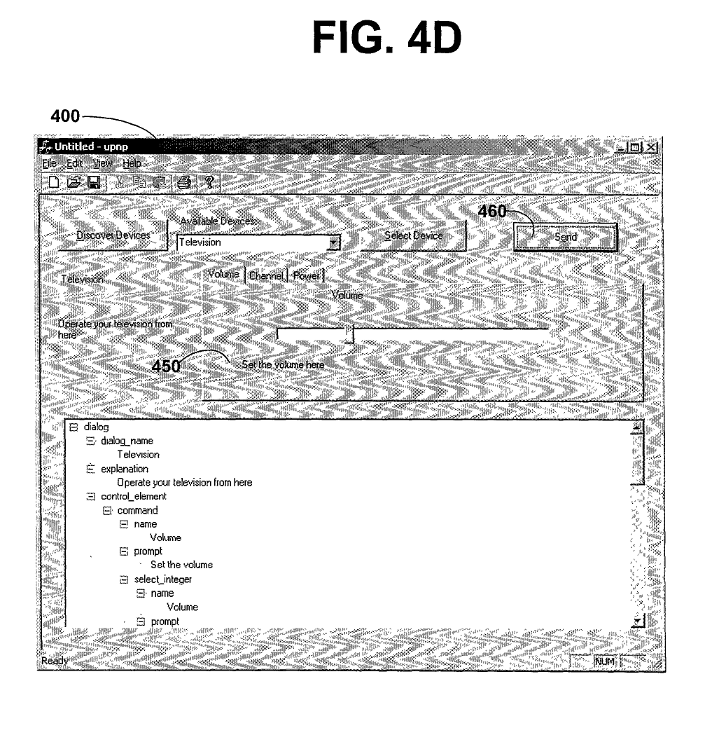

An exemplary UC 200 implemented in a Windows(& environment is shown in FIGS. 4A through 4D. As mentioned, the invention may be implemented in any computing environment, and the actual concrete UI presented to the user may be tailored to the user according to the user's preferences. In FIG. 4A, a UC window 400 contains an instantiation of the UC 200 software. In this particular embodiment, a button 410 for discovering devices that may be controlled by the UC 200 may be entered or clicked in order to cause device discovery to occur. At the point in time illustrated, a menu 420 reflects that no devices are within the control of the UC 200. Once discovered, as shown in FIG. 4B, menu 420 displays which devices may be controlled. A button 430 reflects a user's option to select a particular device to be controlled. Once a device is selected, control options 440 are presented in some fashion to the user according to the user's preferences. In the example, the display illustrates some rudimentary control options for a television.

FIG. 4C illustrates an exemplary operation to be performed by the controlled device, or television. In this case, the user has chosen to modify the volume level of the television, and accordingly a window 450 appears in accordance with the information that the user must add to the parameters of the parameter. In this case, the primary parameter is the volume level, and window 450 appropriately requests this parameter in accordance with user preferences. FIG. 4D illustrates the actual sending of the command via button 460 once the volume level has been specified, thereby completing the level of information necessary to describe the action-command. A concrete UI representation for volume control might also be implemented in other ways, for example, a slider, a knob, etc. might be implemented whereby the user can continuously adjust the parameter(s) associated with a volume change action-command. As the user manipulates the user interface element, the UC 200 sends corresponding commands to the device 300.

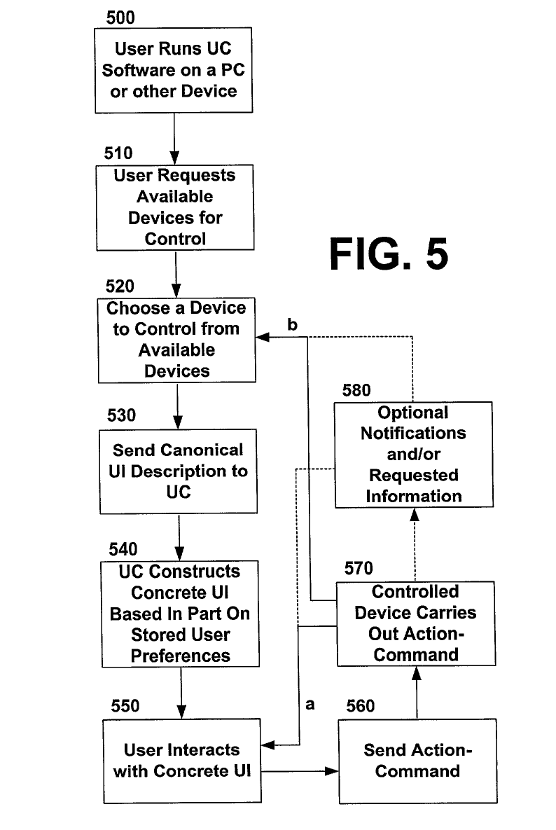

In one embodiment of the present invention, as shown in FIG. 5, a user runs UC software on a PC or device at 500. At 510, the user may request a list of available devices 300 that may be controlled by UC 200. At 520, the user chooses a particular application or device to control (the “server”). At 530, the server sends a canonical UI representation of its abstract UI to the UC 200. As an example, this representation could be in the form of an XML stream, e.g. using the constructs in Appendix A, and could be transmitted using the Hypertext Transfer Protocol (HTTP).

At 540, the UC 200 takes the stored user preferences and uses those to instantiate a concrete UI. At 550, the user interacts with the group hierarchies and such other displayed items as are required to obtain the values of the parameters of all actions the user requests that the server perform. The UC 200 directs the server to perform actions using a remote procedure call mechanism, such as SOAP (Simple Object Activation Protocol). SOAP represents the calls in the form of XML streams, which can be sent via HTTP. At 560, the user has input enough information to send at least one complete action-command to the controlled device 300.

At 570, the controlled device 300 carries out the actions and at 580, the controlled device 300 can optionally send notifications to the user, such as error, warning, status, and informational messages, and/or other requested information. The notifications may be in the form of XML streams e.g., using the constructs in Appendix B. The data streams can be transferred using HTTP. Subsequently, along path a, a user may request another action command, or along path b, the user may choose another device 300 to control. Notifications may also be asynchronous as a result of the computing device 300 changing state.

Localization

The canonical UI thus far presented presumes support for a single language, not necessarily English, per an XML stream. However, in another embodiment, the present invention may support multiple languages. For example, in the Robodog jump example presented above, the Canonical UI of the present invention may have a localization feature that supports additional languages in the same document. Note that the UC 200 can provide nontext localization and globalization, but for each language the document supports there are versions of the text strings in that language. For example, if English, German, and French are supported, each text string, such as titles, prompts, explanations, and the like, includes an English, German, and French version.

For one way of achieving this, wherever text may appear, the following construct can take its place: <display_string index=i> where i is an index. When the UC 200 presents text, it may use the index, in conjunction with the user's language, to look up the localized string. The localized strings themselves appear in the canonical UI document as <string_table> <local_string language=l index=i text=“t”></string_table>. The encoding (e.g. ANSI, Unicode) may be indicated in the same way as for the document as a whole.

In addition, for additional ways of expanding upon or retrieving canonical UI descriptions for controlled devices, the UC 200 may be a networked device connected to the Internet, whereby the UI description or portions thereof, or updates, may be downloaded.

The described method can be implemented using a variety of different technical architectures including both server and client side execution. It may be implemented in code or generated from meta descriptions. The preceding exemplifies merely some of the possible implementation technologies.

The various techniques described herein may be implemented with hardware or software or, where appropriate, with a combination of both. Thus, the methods and apparatus of the present invention, or certain aspects or portions thereof, may take the form of program code (i.e., instructions) embodied in tangible media, such as floppy diskettes, CD-ROMs, DVD-ROMs, ROMs, PROMs, EPROMS, EEPROMs, hard drives, or any other machine-readable storage medium, wherein, when the program code is loaded into and executed by a machine, such as a computer, the machine becomes an apparatus for practicing the invention. In the case of program code execution on programmable computers, the computer will generally include a processor, a storage medium readable by the processor (including volatile and non-volatile memory and/or storage elements), at least one input device, and at least one output device. One or more programs are preferably implemented in a high level procedural or object oriented programming language to communicate with a computer system. However, the program(s) can be implemented in assembly or machine language, if desired. In any case, the language may be a compiled or interpreted language, and combined with hardware implementations.

The methods and apparatus of the present invention may also be embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, a video recorder or the like, the machine becomes an apparatus for practicing the invention. When implemented on a general-purpose processor, the program code combines with the processor to provide a unique apparatus that operates to perform the flagging and information relation functionality of the present invention. For example, the storage techniques used in connection with the present invention may invariably be a combination of hardware and software.

While the present invention has been described in connection with the preferred embodiments of the various Figures, it is to be understood that other similar embodiments may be used or modifications and additions may be made to the described embodiment for performing the same function of the present invention without deviating therefrom.

Furthermore, it should be emphasized that a variety of computer platforms, including handheld device operating systems and other application specific operating systems are contemplated, especially as the number of wireless networked devices continues to proliferate. Therefore, the present invention should not be limited to any single embodiment, but rather construed in breadth and scope in accordance with the appended claims.

| | | | | | |
|---|---|---|---|---|---|
| | Mandatory | | | | IMPLEMEN- |
| | parameters (except | OPTIONAL | RE- | DESCRIP- | TATION |
| Construct | when disabled) | PARAMETERS | TURN | TION | EXAMPLES |

APPENDIX A - Table “Exemplary Canonical UI Input Constructs”

| | | | | | |
|---|---|---|---|---|---|
| <select_one> | - <name> name | - <disabled_control_element/> | a | Parameter | - Menu |
| </select_one> | </name> | - <disabled_option/> | | type for | - Group of radio |
| | - <prompt> p | - <default_option/> | | choosing | buttons |
| | </prompt> | - <per_option_prompt>pop | | one | - Non-editable |
| | - <option> a₁ </option> | </per_option_prompt> | | element | combo box |
| | - <option> a₂ </option> | - <type>t</type> | | a from | |

| | |
|---|---|
| . . . | a set |

| | | | | | |
|---|---|---|---|---|---|
| | <option> aₙ </option> | | | A | |
| <select_subset> | <name> name | - <disabled_control_element/> | A′ | Parameter | - Listbox |
| </select_subset> | </name> | - <disabled_option/> | | type for | - Group of |
| | <prompt> p </prompt> | - <default_option/> | | selecting | checkboxes |
| | <option> a₁ </option> | - <per_option_prompt>pop | | a subset | |
| | <option> a₂ </option> | </per_option_prompt> | | A′ from a | |

| | | |
|---|---|---|
| . . . | - <type>t</type> | set A |

| | | | | | |
|---|---|---|---|---|---|
| | <option> aₙ </option> | | | | |
| <boolean_choice> | <name> name | - <disabled_control_element/> | b | Parameter | - Single |
| </Boolean_choice> | </name> | - <default_FALSE/> | | type for | checkbox |
| | <prompt> p </prompt> | - <default_TRUE/> | | selecting | |
| | | | | True/False | |
| | | | | [or | |
| | | | | Off/On, | |
| | | | | OK/Cancel, | |
| | | | | etc.] | |
| <select_integer> | <name> name | - <disabled_control_element/> | n | Parameter | - Trackbar |
| </select_integer> | </name> | - <default_value> | | type for | - Spinner |
| | <prompt> p </prompt> | </default_value> | | selecting | |
| | <min> n₁ </min> | - <incr> δ </incr> | | an integer | |
| | <max> n₂ </max> | | | n in the | |
| | | | | range n₁ | |
| | | | | through n₂, | |
| | | | | increment δ | |
| <select_real> | <name> name | - <disabled_control_element/> | x | Parameter | - Slider |
| </select_real> | </name> | - <default_value> | | type for | - Dial |
| | <prompt> p </prompt> | </default_value> | | selecting | |
| | <min> x₁ </min> | | | a real | |
| | <max> x₂ </max> | | | number x | |
| | <incr> δ </incr> | | | in the | |
| | | | | range xl | |
| | | | | through x2, | |
| | | | | increment δ | |
| <enter_string> | <name> name | - <suggest> s₁ </suggest> | s | Parameter | - Edit Box |

| | | | | |
|---|---|---|---|---|
| </enter_string> | </name> | <suggest> s₂ | type for an | - Combo Box |
| | <prompt> p </prompt> | </suggest> | arbitrary | |
| | | <suggest> s₃ | string s; | |
| | | </suggest> | possibly | |
| | | . . . | from | |

| | | | | | |
|---|---|---|---|---|---|
| | | - <disabled/> | | suggestion | |
| | | - <default> | | set S. | |
| | | - <max_lengthm</max_length > | | | |
| <modify> | <name> name | | s′ | Parameter | - Initialized edit |
| </modify> | </name> | | | type for the | box |
| | <prompt> p </prompt> | | | modification | |
| | <unmodified_string> s | | | of a given | |
| | </unmodified_string> | | | string s, | |
| | | | | resulting in | |
| | | | | string s′ | |
| <order> | <name> name | | | Parameter | - directory, file |
| </order> | </name> | | | type for | search order |
| | <prompt> p </prompt> | | | ordering the | control |
| | <unmodified_string> s | | | elements of | (examples in |
| | </unmodified_string> | | | set A into A′ | IIS and Visual |
| | | | | | Studio) |
| <associate> | <name> name | | zero or | Parameter | - Example: |
| </associate> | </name> | | more | type for | Mapping table |
| | <prompt> p </prompt> | | ordered | pairing | columns in SQL |
| | <option1> a₁/option1> | | pairs | set A | Server DTS |
| | <option1> a₂/option1> | | (a, b) | elements | |

| | |
|---|---|
| . . . | with set B |

| | |
|---|---|
| < option1> aₙ/option1> | elements |
| <optionl> b₁/option2> | |
| <option2> b₂/option2> | |

. . .

| | | | | | |
|---|---|---|---|---|---|
| | <option2> bₘ/option2> | | | | |
| <group> | <define_dialog_name> | - <top_level/> | | Contains | - Dialog box |
| </group> | dialog_name | - <modal/> | | commands | |
| | </define_dialog_name> | | | and | |
| | <title> s </title> | | | subgroups | |
| | <explanation> e | | | | |
| | </explanation> | | | | |
| <command> | <name> name | - <disabled/> | Con- | Specifies | - Pushbutton |
| </command> | </name> | | tains | the actions | - Hotkey |
| | <prompt> p </prompt> | | SOAP | to send to | - Hardware key |
| | <reference_dialog_name> | | calls | the | |
| | dialog name | | and | controlled | |
| | </reference_dialog_name> | | para- | device that | |
| | <action> a₁ </action> | | meters | will carry | |

| | |
|---|---|
| . . . | out the |

| | |
|---|---|
| <action> aₙ </action> | command. |
| | Includes |
| | description |
| | of the |
| | parameters |
| | needed for |
| | each action. |

APPENDIX B - Table “Exemplary Canonical UI Output Constructs”

| | | | | |
|---|---|---|---|---|
| <matrix title=t | - <ColumnHeaders> | <EmptyElement/> | Allow | - table |
| columns=n>\ | <ColumnHeader>h₁</ColumnHeader> | <EmptyRow/> | matrix to be | |
| </matrix> | <ColumnHeader>h2</ColumnHeader> | | traversed | |

| | |
|---|---|
| . . . | via row or |

| <ColumnHeader>hn</ColumnHeader> | | column in |
|---|---|---|
| </ColumnHeaders> | | different |
| - <Row> | | directions. |
| - | <Label>l </Label> | Allow skip |
| - | <Number>n</Number> | to next or |
| - | <String>s</Number> | previous |

| | | | |
|---|---|---|---|
| | - </Row> | sparse | |
| | | element. | |
| <notification> | | Display an | - message box |
| n | | asynchronous | |
| </notification> | | message | |
| | | describing | |
| | | a condition | |

APPENDIX A - Table “Exemplary Canonical UI Input Constructs”

| | | | | | |
|---|---|---|---|---|---|
| <select_one> | - <name> name | - <disabled/> | a | Parameter | - Menu |
| </select_one> | </name> | - <disabled_option/> | | type for | - Group of radio |
| | - <prompt> p | - <default_option/> | | choosing | buttons |
| | </prompt> | - <per_option_prompt>pop | | one | - Non-editable |
| | - <option> a₁ </option> | </per_option_prompt> | | element a | combo box |
| | - <option> a₂ </option> | - <type>t</type> | | from a | |

| | |
|---|---|
| . . . | set A |

| | | | | | |
|---|---|---|---|---|---|
| | - <option> aₙ </option> | | | | |
| <select_subset> | <name> name | - <disabled/> | A′ | Parameter | - Listbox |
| </select_subset> | </name> | - <disabled_option/> | | type for | - Group of |
| | <prompt> p </prompt> | - <default_option/> | | selecting | checkboxes |
| | <option> a₁ </option> | - <per_option_prompt>pop | | a subset | |
| | <option> a₂ </option> | </per_option_prompt> | | A′ from a | |

| | | |
|---|---|---|
| . . . | - <type>t</type> | set A |

| | | | | | |
|---|---|---|---|---|---|
| | <option> aₙ </option> | | | | |
| <Boolean_choice> | <name> name | - <disabled/> | b | Parameter | - Single |
| </Boolean_choice> | </name> | - <default_FALSE/> | | type for | checkbox |
| | <prompt> p </prompt> | - <default_TRUE/> | | selecting | |
| | | | | True/False | |
| | | | | [or | |
| | | | | Off/On, | |
| | | | | OK/Cancel, | |
| | | | | etc.] | |
| <select_integer> | <name> name | - <disabled_control_element/> | n | Parameter | - Trackbar |
| </select_integer> | </name> | - <default_value> | | type for | - Spinner |
| | <prompt> p </prompt> | </default_value> | | selecting | |
| | <min> n₁ </min> | - <incr> δ </incr> | | an integer | |
| | <max> n₂ </max> | | | n in the | |
| | | | | range n₁ | |
| | | | | through n₂, | |
| | | | | increment δ | |
| <select_real> | <name> name | - <disabled/> | x | Parameter | - Slider |
| </select_real> | </name> | - <default_value> . . . | | type for | - Dial |
| | <prompt> p </prompt> | </default_value> | | selecting a | |
| | <min> x₁ </min> | | | real number | |
| | <max> x₂ </max> | | | x in the | |
| | <incr> δ </incr> | | | range x₁ | |
| | | | | through x₂, | |
| | | | | increment δ | |
| <enter_string> | <name> name | - <suggest> s₁ </suggest> | s | Parameter | - Edit Box |

| | | | | |
|---|---|---|---|---|
| </enter_string> | </name> | <suggest> s₂ | type for an | - Combo Box |
| | <prompt> p </prompt> | </suggest> | arbitrary | |
| | | . . . | string s; | |
| | | <suggest> sₙ | possibly | |
| | | </suggest> | from | |

| | | | | | |
|---|---|---|---|---|---|
| | | - <disabled/> | | suggestion | |
| | | - <default> | | set S. | |
| | | - <max_length>m</max_{—} | | | |
| | | length > | | | |
| <modify> | <name> name | | s′ | Parameter | - Initialized edit |
| </modify> | </name> | | | type for the | box |
| | <prompt> p </prompt> | | | modification | |
| | <unmodified_string> s | | | of a given | |
| | </unmodified_string> | | | string s, | |
| | | | | resulting | |
| | | | | in string s′ | |
| <order> | <name> name | | | Parameter | - directory, file |
| </order> | </name> | | | type for | search order |
| | <prompt> p </prompt> | | | ordering the | control |
| | <element> a₁ </element | | | elements of | (examples in |
| | <element> a₂ </element | | | set A | IIS and Visual |

| | | |
|---|---|---|
| . . . | into A′ | Studio) |

| | | | | |
|---|---|---|---|---|
| | <element> aₙ </element | | | |
| <associate> | <name> name | zero or | Parameter | - Example: |
| </associate> | </name> | more | type for | Mapping table |
| | <prompt> p </prompt> | ordered | pairing | columns in SQL |
| | <elem1> a₁/elem1> | pairs | set A | Server DTS |
| | <elem1> a₂/elem1> | (a, b) | elements | |

| | |
|---|---|
| . . . | with set B |

| | |
|---|---|
| <elem1> aₙ/elem1> | elements |
| <elem2> b₁/elem2> | |
| <elem2> b₂/elem2> | |

. . .

| | | | | |
|---|---|---|---|---|
| | <elem2> bₘ/elem2> | | | |
| <group> | <name> group_name | - <group> . . . </group> | Contains | - Dialog box |
| </group> | </name> | - <command> . . . | commands | |
| | <description> d | </command> | and | |
| | </description> | | subgroups | |

| | | | | | |
|---|---|---|---|---|---|
| <command> | <name> name | - <disabled/> | Con- | Specifies | - Pushbutton |

| | | | | | |
|---|---|---|---|---|---|
| </command> | </name> | - constructs such as select_one | tains | the actions | - Hotkey |
| | <prompt> p </prompt> | that describe action call | action | to send to | - Hardware key |
| | <action> a₁ </action> | parameters | calls | the | |
| | <action> a₂ </action> | | and | controlled | |

| | | |
|---|---|---|
| . . . | para- | device that |

| | | |
|---|---|---|
| <action> aₙ </action> | meters | will carry |
| | | out the |
| | | command. |
| | | Includes |
| | | description |
| | | of the |
| | | parameters |
| | | needed for |
| | | each action. |

APPENDIX B - Table “Exemplary Canonical UI Output Constructs”

| | | | | |
|---|---|---|---|---|
| <matrix title=t | - <ColumnHeaders> | <EmptyElement/> | Allow | - table |
| columns=n> | <ColumnHeader>h₁</ColumnHeader> | <EmptyRow/> | matrix | |
| </matrix> | <ColumnHeader>h₂</ColumnHeader> | | to be | |

| | |
|---|---|
| . . . | traversed |

| <ColumnHeader>hₙ</ColumnHeader> | | via row or |
|---|---|---|
| </ColumnHeaders> | | column in |
| - <Row> | | different |
| - | <Label>l </Label> | directions. |
| - | <Number>n</Number> | Allow skip |
| - | <String>s</String> | to next or |

| | | | |
|---|---|---|---|
| | - </Row> | previous | |
| | | sparse | |
| | | element. | |
| <notification> | | Display a | - message |
| n | | message | box |
| </notification> | | | |

What is claimed is:

1. A method for controlling at least one computing element with a universal console (UC), comprising:
storing a user's preferences for the universal console;
selecting a computing element to control with the UC;
receiving by the UC a canonical user interface (UI) representation of the computing element's UI;
instantiating a concrete UI by the UC taking into account the stored user preferences;
selecting at least one action-command to be carried out by the computing element;
transmitting to the computing element said data associated with said at least one action-command using a remote procedure call mechanism.

2. A method according to claim 1, wherein said selecting at least one action-command includes requesting information about the state of said at least one computing element.

3. A method according to claim 1, further comprising interacting with at least one group hierarchy to obtain data in connection with said selected at least one action-command to be carried out by the computing element.

4. A method according to claim 1, wherein said storing includes storing data indicating at least one disability of the user.

5. A method according to claim 1, further including carrying out said action-command by said computing element.

6. A method according to claim 1, further including receiving by the UC notifications from the computing element.

7. A method according to claim 6, wherein said notifications include at least one of an error message, warning message, status update message and state change.

8. A method according to claim 1, wherein said canonical UI representation is formatted according to an XML stream.

9. A method according to claim 1, further including requesting a list of available devices that may be controlled by UC.

10. A method according to claim 1, wherein communications between said UC and said computing element are made via Hypertext Transfer Protocol (HTTP).

11. A method according to claim 1, wherein said computing element is one from the group of a computing device and an application.

12. A method according to claim 1, wherein said remote procedure call mechanism makes calls according to SOAP (Simple Object Activation Protocol).

13. A method according to claim 1, wherein said canonical UI representation includes a representation associated with a parameter for choosing one element a from a set A.

14. A method according to claim 1, wherein said canonical UI representation includes a representation associated with a parameter for selecting a subset A′ from a set A.

15. A method according to claim 1, wherein said canonical UI representation includes a representation associated with a parameter for selecting one from the group of True/False, Off/On, OK/Cancel and Yes/No.

16. A method according to claim 1, wherein said canonical UI representation includes a representation associated with a parameter for selecting an integer n in the range n₁ through n₂, with increment δ.

17. A method according to claim 1, wherein said canonical UI representation includes a representation associated with a parameter for selecting a real number x in the range x1 through x2, with increment δ.

18. A method according to claim 1, wherein said canonical UI representation includes a representation associated with a parameter type for an arbitrary string s.

19. A method according to claim 18, wherein said arbitrary string s is to be selected from a suggestion set of strings S.

20. A method according to claim 1, wherein said canonical UI representation includes a representation associated with a parameter type for the modification of a given first string s, resulting in a second string s′.

21. A method according to claim 1, wherein said canonical UI representation includes a representation associated with a parameter type for ordering the elements of set A into A′.

22. A method according to claim 1, wherein said canonical UI representation includes a representation associated with a parameter type for pairing set A elements with set B elements.

23. A method according to claim 1, wherein said canonical UI representation includes a representation associated with a group construct that contains at least one of commands and subgroups.

24. A method according to claim 1, wherein said canonical UI representation includes a representation associated with a command construct that specifies at least one action to send to the controlled element that will carry out the action-command.

25. A method according to claim 24, wherein said canonical UI representation includes a description of the parameters associated with the at least one action.

26. A computer readable medium bearing computer executable instructions for carrying out the method of claim 1.

27. A modulated data signal carrying computer executable instructions for use in implementing the method of claim 1.

28. A data structure formatted according to extensible markup language (XML) including data representative of a canonical UI description of a device to be controlled for use by a universal console.

29. A data structure according to claim 28, wherein said canonical UI description includes a representation associated with a parameter for choosing one element a from a set A.

30. A data structure according to claim 29, wherein said canonical UI description includes a representation associated with a parameter for selecting a subset A′ from a set A.

31. A data structure according to claim 28, wherein said canonical UI description includes a representation associated with a parameter for selecting one from the group of True/False, Off/On, OK/Cancel and Yes/No.

32. A data structure according to claim 28, wherein said canonical UI description includes a representation associated with a parameter for selecting an integer n in the range n₁ through n₂, with increment δ.

33. A data structure according to claim 28, wherein said canonical UI description includes a representation associated with a parameter for selecting a real number x in the range x1 through x2, with increment δ.

34. A data structure according to claim 28, wherein said canonical UI description includes a representation associated with a parameter type for an arbitrary string s.

35. A data structure according to claim 34, wherein said arbitrary string s is to be selected from a suggestion set of strings S.

36. A data structure according to claim 28, wherein said canonical UI description includes a representation associated with a parameter type for the modification of a given first string s, resulting in a second string s′.

37. A data structure according to claim 28, wherein said canonical UI description includes a representation associated with a parameter type for ordering the elements of set A into A′.

38. A data structure according to claim 28, wherein said canonical UI description includes a representation associated with a parameter type for pairing set A elements with set B elements.

39. A data structure according to claim 28, wherein said canonical UI description includes a representation associated with a group construct that contains at least one of commands and subgroups.

40. A data structure according to claim 28, wherein said canonical UI description includes a representation associated with a command construct that specifies at least one action to send to the controlled element that will carry out the action-command.

41. A data structure according to claim 40, wherein said canonical UI description includes a description of the parameters associated with the at least one action.

42. A computer system wherein a user controls at least one computing element, said system comprising:
at least one computing element each having a canonical user interface (UI) description associated therewith; and
a universal console (UC) for controlling said at least one computing element and storing user preferences therein;
wherein a computing element of said at least one computing element communicates its associated canonical UI to said UC,
wherein said UC generates a concrete UI description from said canonical UI and said stored user preferences, and
wherein a user thereafter utilizes said UC to control said computing element via said concrete UI by selecting at least one action-command.

43. A computer system according to claim 42, wherein said selecting at least one action-command includes requesting information about the state of said at least one computing element.

44 A computer system according to claim 42, wherein a user of said UC interacts with at least one group hierarchy to obtain data in connection with said selected at least one action-command to be carried out by the computing element.

45. A computer system according to claim 42, wherein said storage of user preferences includes the storage of data indicating at least one disability of the user.

46. A computer system according to claim 42, wherein said at least one computing element carries out said at least one action-command.

47. A computer system according to claim 42, wherein said UC receives notifications from the at least one computing element.

48. A computer system according to claim 47, wherein said notifications include at least one of an error message, warning message, status update message and state change.

49. A computer system according to claim 42, wherein said canonical UI description is formatted according to an XML stream.

50. A computer system according to claim 42, wherein said selecting at least one action-command includes requesting a list of available devices that may be controlled by UC.

51. A computer system according to claim 42, wherein communications between said UC and said computing element are made via Hypertext Transfer Protocol (HTTP).

52. A computer system according to claim 42, wherein said computing element is one from the group of a computing device and an application.

53. A computer system according to claim 42, wherein said remote procedure call mechanism makes calls according to SOAP (Simple Object Activation Protocol).

54. A computer system according to claim 42, wherein said canonical UI description includes a description associated with a parameter for choosing one element a from a set A.

55. A computer system according to claim 42, wherein said canonical UI description includes a description associated with a parameter for selecting a subset A′ from a set A.

56. A computer system according to claim 42, wherein said canonical UI description includes a description associated with a parameter for selecting one from the group of True/False, Off/On, OK/Cancel and Yes/No.

57. A computer system according to claim 42, wherein said canonical UI description includes a description associated with a parameter for selecting an integer n in the range n₁ through n₂, with increment δ.

58. A computer system according to claim 42, wherein said canonical UI description includes a description associated with a parameter for selecting a real number x in the range x1 through x2, with increment δ.

59. A computer system according to claim 42, wherein said canonical UI description includes a description associated with a parameter type for an arbitrary string s.

60. A computer system according to claim 59, wherein said arbitrary string s is to be selected from a suggestion set of strings S.

61. A computer system according to claim 42, wherein said canonical UI description includes a description associated with a parameter type for the modification of a given first string s, resulting in a second string s′.

62. A computer system according to claim 42, wherein said canonical UI description includes a description associated with a parameter type for ordering the elements of set A into A′.

63. A computer system according to claim 42, wherein said canonical UI description includes a description associated with a parameter type for pairing set A elements with set B elements.

64. A computer system according to claim 42, wherein said canonical UI description includes a description associated with a group construct that contains at least one of commands and subgroups.

65. A computer system according to claim 42, wherein said canonical UI description includes a description associated with a command construct that specifies at least one action to send to the controlled element that will carry out the action-command.

66. A computer system according to claim 65, wherein said canonical UI description includes a description of the parameters associated with the at least one action.
